(19) United States
(12) Patent Application Publication
(10) Pub. No.: US 2020/0143026 A1
(43) Pub. Date: May 7, 2020

(54) BIOMETRIC RECOGNITION METHOD AND DEVICE

(71) Applicant: IDEMIA IDENTITY & SECURITY FRANCE, Courbevoie (FR)

(72) Inventors: Cédric THUILLIER, COURBEVOIE (FR); Joël-Yann FOURRE, COURBEVOIE (FR)

(21) Appl. No.: 16/674,621

(22) Filed: Nov. 5, 2019

(30) Foreign Application Priority Data
Nov. 6, 2018 (FR) 1860228

(51) Int. Cl. G06F 21/32; G06K 9/00; G10L 15/22; G06F 3/16; G10L 15/30; G10L 17/22; G10L 13/00

(52) U.S. Cl. CPC G06F 21/32; G06K 9/00093; G10L 15/22; G10L 15/26; G10L 15/30; G10L 17/22; G10L 13/00; G06F 3/167

(57) ABSTRACT

Biometric recognition method using a standard electronic processing unit including a first computer and a first memory and a secure electronic processing unit including a second computer and a second memory, the method including the steps of executing a first part of the recognition steps by the standard processing unit and a second part of the recognition steps by the secure electronic processing unit. Device for the execution of that method.

The present invention concerns the field of biometric recognition.

### TECHNOLOGICAL BACKGROUND

There are known biometric recognition methods used for example for the purposes of identifying a person or verifying the right of the person to access a place or information. Biometric recognition is based on the presence on the body of each person of biometric patterns that are unique to them. Those biometric patterns consist for example of the arrangement of the ridges of the skin on the fingers or the palms of the hands (dermatoglyphs) that form the fingerprints or palm prints, the appearance of the iris, the appearance of the face, and so on. These patterns are termed biometric because it is possible to extract from them features, in particular geometric and dimensional features, enabling one biometric pattern to be distinguished from another.

A biometric recognition method conventionally includes an enrolment phase and a recognition phase.

The enrolment phase includes the steps of:
capturing a biometric pattern on a body part of a reference user (that is to say a user intended to be authorized to access a place or information access to which is to be protected),
extracting features representative of the biometric pattern (these are then referred to as biometric features),
storing the biometric features in a data medium (such as a memory of a computer system, a memory of an integrated circuit card, a memory of a circuit that functions in near field mode and is incorporated into an identity document such as a passport, and so on).

The recognition phase includes the steps of:
capturing a biometric pattern on a body part of a candidate for recognition (that is to say a person wishing to access the place or the information to which access is protected),
extracting features representative of the biometric pattern of the candidate,
calculating a similarity score by comparing the biometric features of the candidate to the biometric features stored in the data medium,
validating recognition if the similarity score is above a validation threshold.

The greater the number of biometric features used for the comparison, the more reliable the recognition. This assumes that:
a large number of stored biometric features is available,
a large number of biometric features is detected on the candidate, and
sufficiently powerful computation resources are available to calculate a similarity score by comparing a large number of biometric features with one another.

Moreover, implementing a biometric recognition method of this kind on electronic devices including a standard electronic processing unit and a secure electronic processing unit is envisaged.

The standard electronic processing unit includes a first computer and a first memory for carrying out standard operations.

The secure electronic processing unit includes a second computer and a second memory for carrying out security operations. The second computer and the second memory are generally part of a secure microcontroller routinely termed a “secure element” and adapted to execute security programs such as encryption or cryptography programs. A disadvantage of secure microcontrollers of this kind is that they have limited computation and storage resources, which limits the number of biometric features that they are able to process.

To execute a biometric recognition method with a device of the aforementioned type there are at present only two possibilities:
either to consider the biometric recognition as a standard operation and to use a large number of biometric features processed by the standard electronic processing unit,
or to consider the biometric recognition as a secure operation and to use a limited number of biometric features processed by the secure electronic processing unit.

In both cases, the robustness of biometric recognition is at risk.

### OBJECT OF THE INVENTION

An aim of the invention is to make it possible to secure the execution of a biometric recognition method.

### SUMMARY OF THE INVENTION

To this end the invention provides a method of biometric recognition using a standard electronic processing unit including a first computer and a first memory and a secure electronic processing unit including a second computer and a second memory, the method including the steps of:
during a preliminary enrolment phase,
   detecting a biometric pattern on a body part of a reference user and extracting reference descriptors from the biometric pattern and reference geometric coordinates of each descriptor,
   storing the reference descriptors in the first memory,
   storing in the second memory the reference geometric coordinates so as to establish a logical link between each of the reference descriptors and the corresponding reference geometric coordinates;
during a recognition phase,
   detecting a biometric pattern on a body part of a candidate and extracting candidate descriptors from the biometric pattern and candidate geometric coordinates from each candidate descriptor,
   the first computer comparing the candidate descriptors to the reference descriptors to identify recognized candidate descriptors and recognized candidate geometric coordinates, the second computer selecting the reference geometric coordinates of the reference descriptors corresponding to the recognized candidate descriptors
   determining a subset of associations between recognised candidate geometric coordinates with selected reference geometric coordinates,
   validating recognition if the subset is consistent.

Accordingly, a first part of the biometric recognition method is handled by the standard electronic processing unit and a second part of the biometric recognition program is handled by the secure electronic processing unit. As the verification of consistency is decisive for biometric recognition it is effected by the secure electronic processing unit and a fraudster cannot fool the biometric recognition by accessing only the standard electronic processing unit since they will not then have access to the reference geometric coordinates or to the consistency verification algorithm. Moreover, the geometric coordinates consists of less data than the descriptors: the result of this is that processing them requires less data processing resources so that the risk of saturation of the secure electronic processing unit is low.

The invention also has for subject matter a device for execution of the above method.

Other features and advantages of the invention will emerge on reading the following description of two particular nonlimiting embodiments of the invention.

### BRIEF DESCRIPTION OF THE DRAWINGS

Reference will be made to the appended drawings, in which:

FIG. 1 is a diagrammatic view of a terminal suitable for a first embodiment of the method according to the invention;

FIG. 2 is a diagrammatic view of a data processing system suitable for a second embodiment of the method according to the invention.

### DETAILED DESCRIPTION OF THE INVENTION

The invention is described here in an application to biometric recognition based on fingerprints. Obviously, the invention is applicable to other types of biometric features and in particular those extracted from palm prints, the iris or the face of a user.

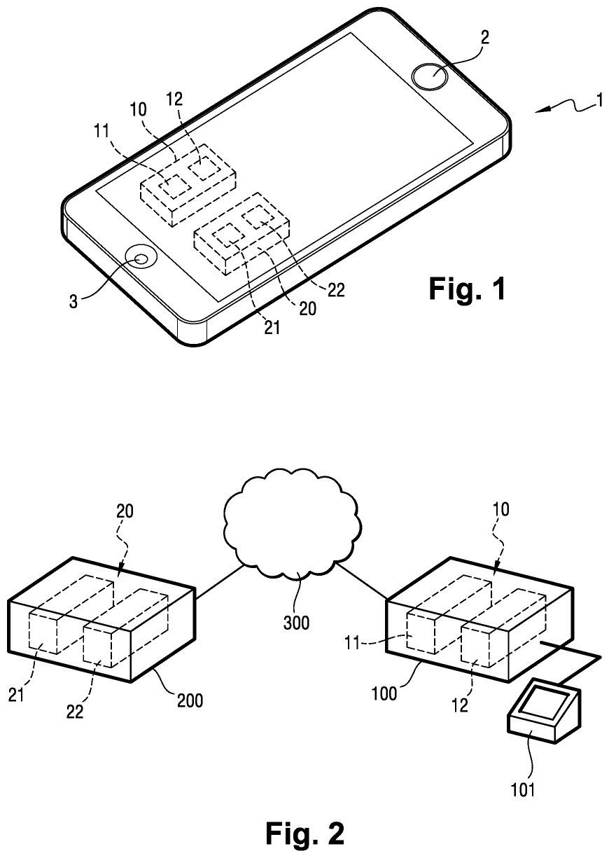

In FIG. 1 there is represented a telecommunication device or terminal 1, here a smart phone, which in the manner known in itself includes a camera 2, a print sensor 3, a standard electronic processing unit 10 and a secure electronic processing unit 20.

The standard electronic processing unit 10 (here a microcontroller or MCU) includes a first computer 11 and a first memory 12. The standard electronic processing unit 10 is adapted and programmed in a manner known in itself to execute standard tasks such as, for example: connecting to the cellular network to make a telephone call or to browse the Internet; playing back videos or music; managing accounts; word processing, using a spreadsheet, using a calculator; capturing and modifying images, and so on. To this end, the standard electronic processing unit 10 executes an operating system enabling it to manage the operation of all the resources of the telecommunication terminal 1 (camera 2, battery, screen, radio-frequency signal transmit/receive circuit, geolocation satellite signal receiver, memory, and so on) and programs (or applications) dedicated to the execution of particular tasks (word processing, image capture, Internet browsing, games, and so on). Some of these dedicated programs can command an authentication operation to be executed by the secure electronic processing unit 20.

The secure electronic processing unit 20 (commonly termed the SE) includes a second computer 21 and a second memory 22. The secure electronic processing unit 20 is adapted and programmed in a manner that is known in itself to constitute an electronic device of the type commonly termed a “secure element” and handling the execution of the security tasks such as password management and encryption, in particular with a view to effecting authentication operations to unlock the telecommunication terminal and/or to use the telecommunication terminal as a contactless payment means and/or as an online payment means, for example via the Internet. The secure electronic processing unit 20 is adapted in a manner that is known in itself to conform to the specifications published by the GLOBALPLATFORM organization.

The standard electronic processing unit 10 and the secure electronic processing unit 20 are interconnected so as to be able to exchange data. The secure electronic processing unit 20 is also connected directly to a radio-frequency signal transmit/receive circuit of the communication terminal 1 to be able to connect to the computer server of a so-called trusted third party involved in payment operations and to exchange data with that computer server without causing the data to pass through the standard electronic processing unit 10.

According to the invention, the telecommunication terminal 1 is programmed to execute a biometric recognition method.

That biometric recognition method includes a preliminary enrolment phase and a recognition phase.

During the preliminary enrolment phase the method includes the steps of:
detecting a biometric pattern on a body part of a reference user and extracting reference descriptors from the biometric pattern and reference geometric coordinates of each descriptor,
storing the reference descriptors in the first memory 12,
storing the reference geometric coordinates in the second memory 22 so as to establish a logical link between each of the reference descriptors and the corresponding reference geometric coordinates.

Here the biometric pattern is a fingerprint and the print sensor 3 may be an optical sensor that supplies a binary image of the biometric pattern to the first computer 11. Other types of sensor may be used such as a capacitive sensor, an ultrasound sensor, a semiconductor sensor, an electric field sensor, and so on.

This image is then processed to detect the biometric pattern and then to extract from the biometric pattern descriptors corresponding to points of interest of the biometric pattern and the geometric coordinates of those points of interest. The points of interest are for example selected from the extrema (minima or maxima) of the image. Here the computer 11 employs an SIFT or SURF type algorithm to extract the reference descriptors, the number of which is between 100 and 200 inclusive. The reference descriptors concern for example the local shape of the geometric pattern (arch, swirl, loop, fork, line end, island, and so on) or a local gradient, and so on. The reference geometric coordinates are measured in a predefined frame of reference positioned relative to the edges of the biometric pattern or to the centre of the latter. The geometric coordinates comprise an abscissa, an ordinate and where applicable an angle of the line forming the biometric pattern at the point of interest.

A plurality of images of the biometric pattern are advantageously captured and the points of interest selected are those appearing in a plurality of those images.

Here the logical link is an index. Each reference descriptor and the corresponding reference geometric coordinates are respectively stored in the first memory 12 and the second memory 22 with the same index. It is also possible to convert the index using a cryptographic or non-cryptographic injective function.

During the recognition phase the method includes the steps of:
detecting a biometric pattern on a body part of a candidate and extracting candidate descriptors from the biometric pattern and candidate geometric coordinates from each candidate descriptor;
the first computer 11 comparing the candidate descriptors to the reference descriptors to identify recognized candidate descriptors and recognized candidate geometric coordinates;
the second computer 21 selecting the reference geometric coordinates of the reference descriptors corresponding to the recognized candidate descriptors;
the second computer 21 verifying consistency of a set of recognized candidate geometric coordinates with a set of selected reference geometric coordinates;
validating recognition if the two sets are consistent.

Detecting the candidate biometric pattern and extracting the candidate descriptors in association with their geometric coordinates are carried out as before.

A candidate descriptor is recognized if it corresponds to a reference descriptor. The descriptors are compared with one another in the conventional manner including for example the computation of a similarity score for each combination of descriptors. Either the similarity score may be compared directly to a threshold or the difference between the best similarity score and the second best similarity score is computed and that difference is compared to a threshold.

The list of recognized candidate geometric coordinates (that is to say the candidate coordinates of the recognized candidate descriptors) each associated with the index of the corresponding reference descriptor is then transmitted by the first computer 11 to the secure electronic processing unit 20.

The second computer 21 thereafter selects the reference coordinates having an index appearing in the list of recognized candidate geometric coordinates to form the set of selected reference geometric coordinates.

There is then available a set of combinations each including reference geometric coordinates and candidate geometric coordinates. The algorithm used is adapted to find in this set a subset exhibiting consistency, that is to say a single simple conversion of the plane making it possible to go from the reference geometric coordinates of that subset to the candidate geometric coordinates. Here the method is designed to test successively conversions each consisting of a rotation or a translation. For each conversion, the combinations separated after conversion by a distance less than a predetermined threshold are retained and form a subset. The conversion yielding the largest subset is retained and said subset is considered consistent. Alternatively, the algorithm looks for consistencies between the combinations two by two by looking for the conversion making it possible to go from the reference geometric coordinates to the candidate geometric coordinates of a combination and by calculating the distance separating the candidate geometric coordinates from another combination and the coordinates obtained by applying the conversion to the reference geometric coordinates of said other combination. That distance is representative of the consistency between the two combinations. The conversion is selected from the following conversions: translations, rotations, similarities, affine conversions, nomography, and so on.

According to a first variant of the first embodiment, the invention is executed using a telecommunication device or terminal, here a smart phone, which includes in the manner known in itself a camera, a print sensor, a standard electronic processing unit and an integrated circuit card reader. The device is adapted to function in association with an integrated circuit card incorporating a secure electronic processing unit.

Operation is identical to that described above with the only difference being that the list of recognized candidate geometric coordinates each associated with the index of the corresponding reference descriptor is transmitted by the first computer 11 out of the device, to the secure electronic processing unit 20, so that the latter effects the verification of consistency and the validation.

According to a second variant the integrated circuit of the card includes the standard electronic processing unit and the secure electronic processing unit 20. The device includes a print sensor, an integrated circuit card reader and an electronic processing unit for transmitting the biometric features to the card, which performs all of the processing.

According to a third variant the integrated circuit of the card includes the standard electronic processing unit and the secure electronic processing unit 20. The card further includes a print sensor connected to the integrated circuit. The card then handles the capture of the print and all the subsequent processing.

In the second embodiment shown in FIG. 2 the standard electronic processing unit 10 and the secure electronic processing unit 20 are parts of respective separate devices 100, 200 connected to one another by a data network 300 such as the Internet.

Here the devices 100 and 200 are two computers but they may have different structures. In particular, the device 100 may be a telecommunication terminal.

The device 100 is connected to a fingerprint sensor 101.

The device 100 has no particular specific feature unless that is to execute a program implementing the method of the invention.

The devices 100 and 200 have a host card emulation (HCE) software architecture enabling the device 100 to transfer data to the server 200 that will process it in the manner of a secure microcontroller of the “secure element” type.

The method of the invention is executed in exactly the same way as that described above and includes the steps of:
detecting a biometric pattern on a body part of a candidate by means of the print sensor 101 and extracting candidate descriptors of the biometric pattern and the candidate geometric coordinates of each candidate descriptor;
the first computer 11 comparing the candidate descriptors to the reference descriptors to identify recognized candidate descriptors and recognized candidate geometric coordinates;
transferring to the second computer 22 the indices of the recognized candidate descriptors or a correspondence function in the form of an index injection;
the second computer 21 selecting the reference geometric coordinates of the reference descriptors corresponding to the indices of the recognized candidate descriptors;
the second computer 21 verifying the consistency of the set of recognized candidate geometric coordinates with the set of selected reference geometric coordinates;
validating the recognition if the two sets are consistent.

For its part, enrolment may have been performed using the print sensor 101 of the device 100 or a print sensor connected to the device 102.

Of course, the invention is not limited to the embodiments described and encompasses any variant within the scope of the invention as defined by the claims.

In particular, other devices may be used to execute the invention, such as a multimedia tablet for example.

By biometric pattern is meant any arrangement of lines that is present on or in a body part of a person and that is unique to that person. Those lines may for example be formed by:
grooves on the skin,
blood vessels,
the delimitation on the face of external parts of organs or orifices or marks (mouth, eyes, nose, blemishes, scars, and so on),
spots and/or striations formed by the iris, and so on.

The descriptors may be classed in any order, for example in a random manner.

Dummy descriptors may be added to the reference descriptors or to the candidate descriptors in order to make fraud more complicated. These dummy descriptors are identified by means of the index associated with them for example.

The same list of reference descriptors may include reference descriptors belonging to two distinct prints. The indices are then preferably used to determine to which print each descriptor belongs.

It is possible to use algorithms other than SIFT or SURF, such as for example Orb, Kaze, Akaze, Brisk, and so on.

Consistency may be verified by means other than those indicated. It is in particular possible to use methods matching points such as non-rigid point set registration methods (https://en.wikipedia.org/wiki/Point set registration).

1. Method A method of biometric recognition using a standard electronic processing unit including a first computer and a first memory and a secure electronic processing unit including a second computer and a second memory, the method including the steps of:
during a preliminary enrolment phase,
detecting a biometric pattern on a body part of a reference user and extracting reference descriptors from the biometric pattern and reference geometric coordinates of each descriptor,
storing the reference descriptors in the first memory,
storing in the second memory the reference geometric coordinates so as to establish a logical link between each of the reference descriptors and the corresponding reference geometric coordinates;
during a recognition phase,
detecting a biometric pattern on a body part of a candidate and extracting candidate descriptors from the biometric pattern and candidate geometric coordinates from each candidate descriptor,
the first computer comparing the candidate descriptors to the reference descriptors to identify recognized candidate descriptors and recognized candidate geometric coordinates, the second computer selecting the reference geometric coordinates of the reference descriptors corresponding to the recognized candidate descriptors
determining a subset of associations between recognised candidate geometric coordinates with selected reference geometric coordinates,
validating recognition if the subset is consistent.

2. The method according to claim 1, in which the standard electronic processing unit and the secure electronic processing unit are part of a single device.

3. The method according to claim 2, in which the device is a wireless communication terminal.

4. The method according to claim 1, in which the standard electronic processing unit and the secure electronic processing unit are parts of two separate devices.

5. The method according to claim 1, in which at least the secure electronic processing unit forms part of an integrated circuit of an integrated circuit card.

6. The method according to claim 1, in which the logical link is an index, each reference descriptor and the reference geometric coordinates that correspond to it being stored in the first memory and the second memory respectively with the same index or a function applied to that index.

7. The method according to claim 1, in which the descriptors are extracted by means of an algorithm of one of the following types: SIFT, SURF, Orb, Kaze, Akaze, Brisk.

8. The method according to claim 1, in which consistency verification includes:
selecting a plurality of geometric conversions of the plane,
establishing a plurality of subsets of combinations of coordinates, the reference geometric coordinates being linked to the candidate geometric coordinates by geometric conversions, the geometric conversion being different for each subset;
calculating a cardinal number of each subset of coordinates and comparing the cardinal number or a function applied to the latter to a threshold,
retaining the subset having the highest cardinal number above the threshold.

9. The method according to claim 1, in which consistency verification includes the execution of a method of graph searching and searching for adjacent points.

10. A device including at least one electronic unit with a first computer and a first memory executing a computer program including instructions adapted to execute a method according to claim 1.

11. The device according to claim 10, including two electronic units, namely a standard electronic processing unit including a first computer and a first memory and a secure electronic processing unit including a second calculator and a second memory, the electronic units executing a computer program including instructions adapted to execute a method according to claim 1.

12. The device according to claim 11, including a print sensor connected to the standard electronic processing unit.

13. The device according to claim 11, the device being an integrated circuit card.
